(19) United States
(12) Patent Application Publication
(10) Pub. No.: US 2019/0355089 A1
(43) Pub. Date: Nov. 21, 2019

(54) IMAGE MOTION COMPENSATION DEVICE AND METHOD

(71) Applicant: MStar Semiconductor, Inc., Hsinchu Hisen (TW)

(72) Inventors: Bang-Sian LIU, Hsinchu Hisen (TW); Yu-Cheng TSENG, Hsinchu Hsien (TW)

(21) Appl. No.: 16/170,713

(22) Filed: Oct. 25, 2018

(30) Foreign Application Priority Data
May 17, 2018 (TW) 107116822

(51) Int. Cl. G06T 1/60; G06T 3/40; G06T 7/207

(52) U.S. Cl. CPC G06T 1/60; G06T 7/207; G06T 3/4007

(57) ABSTRACT

An image motion compensation device includes: a motion vector information processing circuit, generating an image interpolation phase and a motion vector status according to motion vector information of a front image and a rear image; a cache memory circuit, allocates first and second memory spaces to respectively store first-range pixels of the front image and second-range pixels of the rear image read from an external memory circuit; a memory allocation control circuit, generating an allocation control signal according to the image interpolation phase and the motion vector status to control the cache memory circuit to dynamically allocate sizes of the first and second memory spaces; and an image motion compensation circuit, generating, based on the first-range and second-range pixels, an interpolation image corresponding to the image interpolation phase according to the motion vector information and the allocation control signal.

This application claims the benefit of Taiwan application Serial No. 107116822, filed May 17, 2018, the subject matter of which is incorporated herein by reference.

### BACKGROUND OF THE INVENTION

### Field of the Invention

The invention relates to image processing technologies, and more particularly to an image motion compensation device and method.

### Description of the Related Art

Image motion compensation is a technology extensively applied in the field of image processing. For example, when an image is to be converted from a lower frame rate to a higher frame rate, interpolation images needed to be generated by means of the motion compensation technology.

In the image motion compensation technology, an interpolation frame is generated based on a front image and a rear image. In some techniques, a memory space having a larger space but a slower speed is used to store the front image and the rear image, and a cache memory having a smaller space but a faster speed is used to store a part of information of the front image and the rear image so as to perform interpolation computation. However, a cache memory has a quite limited space that can access image blocks of only a part of the front image and the rear image. In some techniques, one half of a cache memory is used for storing image blocks associated with the front image, while the other half is used for storing image blocks of the rear image. However, the fixed cache memory space allocation cannot more effectively utilize memory spaces and pose substantial restrictions on the extent to which motion compensation can be performed.

### SUMMARY OF THE INVENTION

In view of the issue of the prior art, it is an object of the present invention to provide an image motion compensation device and method to improve the prior art.

It is an object of the present invention to provide an image motion compensation method capable dynamically controlling the numbers of first-range pixels and second-range pixels accessed by a cache memory circuit, so as to flexibly utilize the capacity of the cache memory circuit.

An image motion compensation device according to an embodiment of the present invention includes a motion vector information processing circuit, a cache memory circuit, a memory allocation control circuit and an image motion compensation circuit. The motion vector information processing circuit generates an image compensation phase and a motion vector status according to a plurality of sets of motion vector information between a front image and a rear image. The cache memory circuit allocates a first memory space and a second memory space to respectively store first-range pixels of the front image and second-range pixels of the rear image accessed from an external memory circuit. The memory allocation control circuit generates an allocation control signal according to the image interpolation phase and the motion vector status to control the cache memory circuit to dynamically allocate sizes of the first memory space and the second memory space. The image motion compensation circuit generates, based on the first-range pixels and the second-range pixels, an interpolation image corresponding to the image interpolation phase according to the motion vector information and the allocation control signal.

An image motion compensation method applied to an image motion compensation device according to another embodiment of the present invention includes steps of: generating an image interpolation phase and a motion vector status according to a plurality of sets of motion vector information between a front image and a rear image; generating an allocation control signal according to the image interpolation phase and the motion vector status to control a cache memory circuit to allocate a first memory space and a second memory space, so as to respectively store first-range pixels of the front image and second-range pixels of the rear image accessed from an external memory circuit; and generating, based on the first-range pixels and the second-range pixels, an interpolation image corresponding to the image interpolation phase according to the motion vector information and the allocation control signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image processing device according to an embodiment of the present invention;

FIG. 2 is a block diagram of an image motion compensation device according to an embodiment of the present invention;

FIG. 3 is a three-dimensional schematic diagram of a front image earlier in time, a rear image later in time and an interpolation image therebetween between a pair of adjacent images according to an embodiment of the present invention;

FIG. 4 is a schematic diagram of the front image and the rear image in FIG. 3 along an axial direction of a scan line according to an embodiment of the present invention;

FIG. 5 is a detailed block diagram of a search range detecting circuit according to an embodiment of the present invention;

FIG. 6A and FIG. 6B are respectively allocation schematic diagrams of a first memory space and a second memory space according to an embodiment of the present invention;

FIG. 7A and FIG. 7B are respectively allocation schematic diagrams of a first memory space and a second memory space according to an embodiment of the present invention;

FIG. 8A and FIG. 8B are respectively allocation schematic diagrams of a first memory space and a second memory space according to an embodiment of the present invention;

FIG. 9 is a block diagram of an image motion compensation device according to another embodiment of the present invention;

FIG. 10A and FIG. 10B are respectively schematic diagrams of a front image and a rear image according to an embodiment of the present invention;

FIG. 11A and FIG. 11B are respectively schematic diagrams of a front image and a rear image according to an embodiment of the present invention; and

FIG. 12 is a flowchart of an image motion compensation method according to an embodiment of the present invention.

### DETAILED DESCRIPTION OF THE INVENTION

It is an object of the present invention to provide an image motion compensation device and method capable of dynamically controlling the numbers of first-range pixels and second-range pixels accessed by a cache memory circuit, so as to flexibly utilize the capacity of the cache memory circuit.

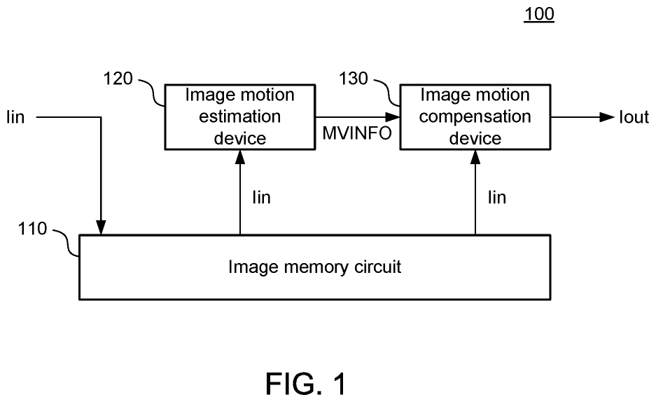

FIG. 1 shows a block diagram of an image processing device 100 according to an embodiment of the present invention. Referring to FIG. 1, the image processing circuit 100 includes an image memory circuit 110, an image motion estimation device 120 and an image motion compensation device 130.

The image memory circuit 100 stores a plurality of images Iin, of each which includes multiple pixels. In one embodiment, the image memory circuit 100 includes a dynamic random-access memory (DRAM).

The image motion estimation device 120 receives the images Iin from the image memory circuit 100 to generate a plurality of sets of motion vector information MVINFOR between every two images Iin. In one embodiment, each set of motion vector information MVINFO represents information related to the motion of the same object between two corresponding images Iin, for example but not limited to, the direction and magnitude of the motion. In different embodiments, the image motion estimation device 120 may adopt different estimation techniques to generate the plurality of sets of motion vector information MVINFO between every two images Iin, and the present invention is not limited to a specific motion estimation technique.

The image motion compensation device 130 receives the images Iin from the image memory circuit 100, and then receives the motion vector information MVINFO from the image motion estimation device 120, so as to perform calculation on every pair of adjacent images Iin according to the motion vector information MVINFO to generate an interpolation image Iout.

Components and operation details of the image motion compensation device 130 are described below.

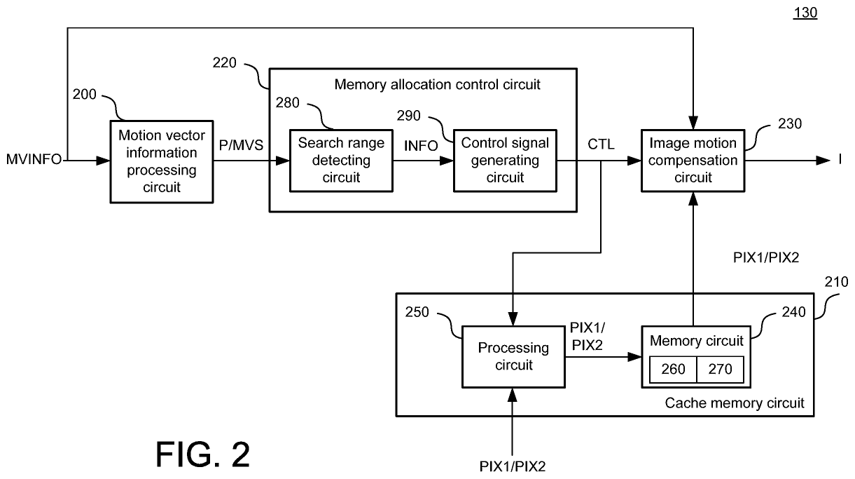

FIG. 2 shows a block diagram of the image motion compensation device 130 according to an embodiment of the present invention. Referring to FIG. 2, the image motion compensation device 130 includes a motion vector information processing circuit 200, a cache memory circuit 210, a memory allocation circuit 220 and an image motion compensation circuit 230.

The motion vector information processing circuit 200 receives from the image motion estimation device 120 the motion vector information MVINFO of a pair of images, including a front image and a rear image among the images Iin, to generate an image interpolation phase P and a motion vector status MVS.

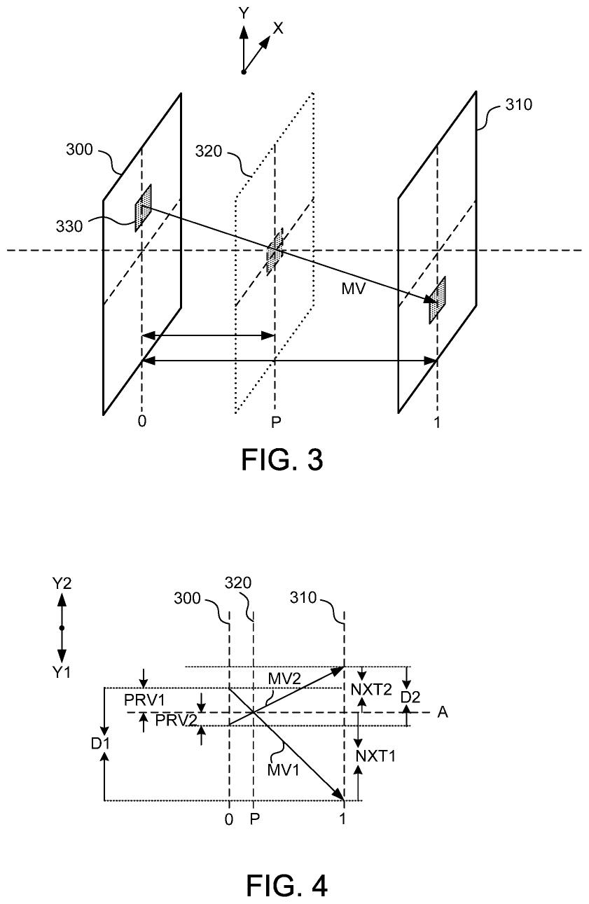

FIG. 3 shows a front image 300 earlier in time, a rear image 310 later in time and an interpolation image 320 therebetween between a pair of adjacent images Iin.

In one embodiment, the front image 300 and the rear image 310 both include an object 330. Thus, a motion path of the object 330 from the front image 300 to the rear image 310 is the motion vector MV of the object 330. In one embodiment, to read the pixels included in the front image 300 and the rear image 310, the pixels are read one line after another along the axial direction X of a scan line. Thus, the motion vector MV simultaneously includes a displacement amount of the axial direction X of the scan line and a displacement amount of another axial direction Y.

The interpolation image 320 is between the front image 300 and the rear image 310. When positions of the front image 300 and the rear image 310 are respectively represented in terms of a phase as 0 and 1, the interpolation image 320 has an interpolation phase P. In one embodiment, image interpolation is performed when the images Iin are converted from a lower frame rate to a higher frame rate. For example, when the frame rate changes from 24 Hz to 60 Hz, the densities of images before and after the conversion are in a ratio of 5:2; that is, every two images before the conversion correspond to five images after the conversion.

If the positions of the front image 300 and the rear image 310 are respectively indicated in terms of phases as 0 and 1, the first image after the conversion is located at the position of the front image 300 and has a phase of 0. The second image after the conversion is generated at a position where the interpolation phase P is 0.4. The third image after the conversion is generated at a position where the interpolation phase P is 0.8. The fourth and the fifth images after the conversion are respectively generated at positions where the interpolation phase is 1.2 and 1.6, i.e., between the rear image and a closely following image (not shown). The sixth image after the conversion is generated at a position following the rear image 310.

The motion vector information processing circuit 200 receives the motion vector information MVINFO from the image motion estimation device 120, wherein the motion vector information MVINFO may include information associated with the image interpolation phase P and the motion vector MV. The motion vector information processing circuit 200 may perform statistical calculation on the object displacement amount in the motion vector information MVINFO to generate the motion vector status MVS. In one embodiment, the motion vector information processing circuit 200 calculates the object displacement amount corresponding to the axial direction Y.

FIG. 4 shows a side schematic diagram of the front image 300 and the rear image 310 along the axial direction X of the scan line according to an embodiment of the present invention.

In one embodiment, a motion vector MV1 and a motion vector MV2 exist between the front image 300 and the rear image 310. The motion vector MV1 has an object displacement amount D1 corresponding to a first direction Y1 and the motion vector V2 has an object displacement amount D2 corresponding to a second direction Y2.

In one embodiment, the statistical calculation performed by the motion vector information processing circuit 200 may include all object displacement amounts corresponding to the first direction Y1 and the second direction Y2. Further, in one embodiment, the motion vector information processing circuit 200 may calculate a first maximum object displacement amount corresponding to the first direction Y1 and a second maximum object displacement amount corresponding to the second direction Y2 for each block included in the front image 300 and the rear image 310.

Thus, after the processing performed on the motion vector information MVINFO, the motion vector information processing circuit 200 generates the image interpolation phase P and the motion vector status MVS including the statistical calculation result.

In one embodiment, the cache memory circuit 210 includes a memory circuit 240 and a processing circuit 250.

In one embodiment, the memory circuit 240 is, for example but not limited to, a static random-access memory (SRAM), which has a fast access speed relative to a DRAM. The memory circuit 240 includes a first memory space 260 and a second memory space 270.

The processing circuit 250 allocates the first memory space 260 and the second memory space 270 according to an allocation control signal CTL, so as to respectively store first-range pixels PIX1 in the front image 300 and second-range pixels PIX2 in the rear image 310 accessed from an external memory circuit, for example but not limited to, the image memory circuit 110 in FIG. 1. As previously described, the processing circuit 250 reads pixels one line after another along the axial direction X of the scan line. Thus, the first memory space 260 stores the first-range pixels having a first scan line count, and the second memory space 270 stores the second-range pixels PIX2 of a second scan line count. In one embodiment, the total of the first memory space 260 and the second memory space 270 is not larger than a predetermined value (e.g., a memory space for later storing pixels of 4H scan lines).

The memory allocation circuit 220 generates the allocation signal CTL at least according to the image interpolation phase P and the motion vector status MVS, so as to control the cache memory circuit 210 to dynamically allocate the sizes of the first memory space 260 and the second memory space 270.

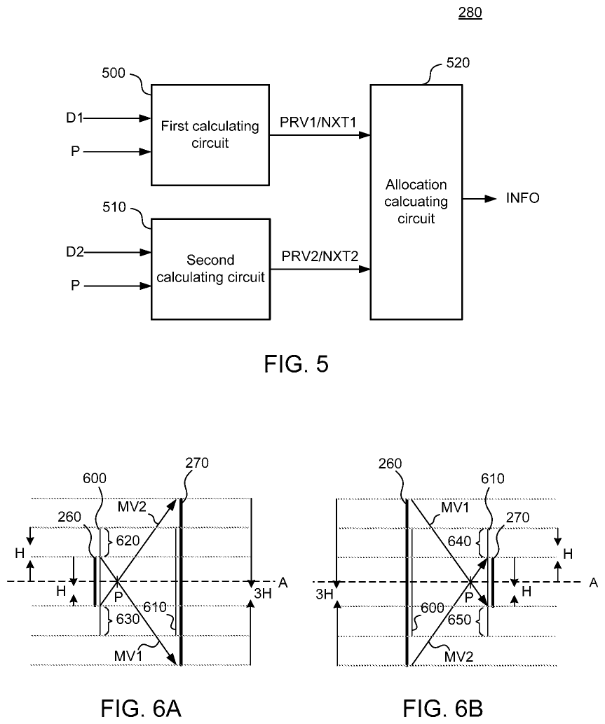

In one embodiment, the memory allocation control circuit 220 includes a search range detecting circuit 280 and a control signal generating circuit 290. FIG. 5 a block diagram of the search range detecting circuit 280 according to an embodiment of the present invention. The search range detecting circuit 280 includes a first calculating circuit 500, a second calculating circuit 510 and an allocation calculating circuit 520. The first calculating circuit 500 generates a first image search range PRV1 and a first rear image search range NXT1 according to the first maximum object displacement amount and the image interpolation phase P. Taking the image in FIG. 4 for example, when the first object maximum displacement amount is the object displacement amount D1, the first calculating circuit 500 can calculate the first front image search range PRV1 and the first rear image search range NXT1 relative to the axis A. In one embodiment, the axis A is the center axis of the block.

The second calculating circuit 510 calculates a second front image search range PRV2 and a second rear image search range NXT2 according to the second maximum object displacement amount and the image interpolation phase P. Taking the image in FIG. 4 for example, when the second maximum object displacement amount is the object displacement amount D2, the second calculating circuit 510 can calculate the second front image search range PRV2 and the second rear image search range NXT2 relative to the axis A.

The allocation calculating circuit 520 generates a front image search range based on the first front image search range PRV1 and the second front image search range PRV2, generates a rear image search range based on the first rear image search range NTX1 and the second rear image search range NXT2, and determines the first scan line count and the second scan line count of the first-range pixels PIX1 and the second-range pixels PIX to accordingly generate allocation information INFO.

The control signal generating circuit 290 controls the cache memory circuit 210 according to the allocation information INFO to dynamically allocate the sizes of the first memory space 260 and the second memory space 270. Further, the image motion compensation circuit 230 accesses the cache memory circuit 210 according to the motion vector information MVINFO and the allocation control signal CTL, so as to generate, based on the first-range pixels PIX1 and the second-range pixels PIX2, an interpolation image I corresponding to the image interpolation phase P.

An example of the allocation of the first memory space 260 and the second memory space 270 is described in detail below. FIG. 6A and FIG. 6B are respectively allocation schematic diagrams of the first memory space 260 and the second memory space 270 according to an embodiment of the present invention.

In one embodiment, the space of the memory circuit 240 can at most store pixels of 4H scan lines. The memory circuit 240 further includes a first predetermined memory space predetermined to store pixels of a front image and a second predetermined memory space 610 predetermined to store pixels of a rear image. The first predetermined memory space 600 and the second predetermined memory space 700 have the same size, and are capable or respectively storing front image blocks and rear image blocks of pixels of 2H scan lines, where H is a positive integer.

In FIG. 6A, the motion vector MV1 and the motion vector MV2 are respectively motion vectors respectively having the first maximum object displacement amount and the second maximum object displacement amount. Starting points of the first motion vector MV1 and the second motion vector MV2 are respectively at 0.5H scan lines above and below the center axis A of the image blocks, and ending points thereof are respectively at 1.5H scan lines below and above the center axis A of the image blocks. Further, the first motion vector MV1 and the second motion vector MV2 respectively have the first maximum object displacement amount and second maximum object displacement amount, and the first maximum object displacement amount and second maximum object displacement amount are both 2H.

According to the first maximum object displacement amount, the second maximum object displacement amount and the image interpolation phase P, the first calculating circuit 500 and the second calculating circuit 510 in FIG. 5 learns through calculation that the first front image search range PRV1 and the second front image search range PRV2 are both 0.5H, and the first rear image search range NXT1 and the second rear image search range NXT2 are both 1.5H. The allocation calculating circuit 520 generates a front image search range having a size of H based on the first front image search range PRV1 and the second front image search range PRV2, and generates a rear image search range having a size of 3H based on the first rear image search range NXT1 and the rear image search range NXT2.

As shown in FIG. 6A, because the image interpolation phase P is smaller than 0.5, the allocation calculating circuit 520 dynamically allocates space sections 620 and 630 of the first predetermined memory space 600 to the second predetermined memory space 610, so as to form the final allocated first memory space 260 and second memory space 270. The sizes of the space sections 620 and 630 are both S, which may be represented as:

S=H−2H×P

Thus, the first memory space 260 becomes 2×(H−S)=2×(H−(H−2H×P))=4H×P; the second memory space 270 becomes 2×(H+S)=2×(H−2H×P))=4H−4H×P. When the image interpolation phase P is, for example, 0.25, the first memory space 260 becomes H and the second memory space 270 becomes 3H. More specifically, the first memory space 260 is capable of storing the first-range pixels PIX1 of H scan lines, and the second memory space 270 is capable of storing second-range pixels PIX2 of 3H scan lines. With the above allocation, the image motion compensation circuit 230 can access the first-range pixels PIX2 of H scan lines and the second-range pixels PIX2 of 3H scan lines, and perform interpolation according to the image interpolation phase P.

In contrast, in FIG. 6B, the starting points of the motion vector MV1 and the motion vector MV2 are respectively at 1.5 scan lines above and below the center axis A of the image blocks, and the ending points thereof are respectively at 0.5H scan lines below and above the center axis A of the image blocks. Further, the first motion vector MV1 and the second motion vector MV2 respectively have the first maximum object displacement amount and the second maximum object displacement amount, and the first maximum object displacement amount and second maximum object displacement amount are both 2H. According to the first maximum object displacement amount, the second maximum object displacement amount and the image interpolation phase P, the first calculating circuit 500 and the second calculating circuit 510 in FIG. 5 can learn through calculation that the first front image search range PRV1 and the second front image search range PRV2 are both 1.5H, and the first rear image search range NXT1 and the second rear image search range NTX2 are both 0.5H. The allocation calculating circuit 520 generates the front image search range having a size of 3H based on the first front image search range PRV1 and the second front image search range PRV2, and generates the rear image search range having a size of H based on the first rear image search range NXT1 and the second rear image search image NXT2.

As shown in FIG. 6B, because the image interpolation phase P is greater than 0.5, the allocation calculating circuit 520 dynamically allocates space sections 640 and 650 of the second predetermined memory space 610 to the first predetermined memory space 600, so as to form the final allocated first memory space 260 and second memory space 270. The sizes S of the space sections 640 and 650 are represented as an equation below:

S=H−2H×(1−P)

Thus, the first memory space 260 becomes 2×(H+S)=2×(H+(H−2H×(1−P)))=4H×P, and the second memory space 270 becomes 2×(H−S)=2×(H−(H−2H×(1−P)))=4H−4H×P. When the image interpolation phase P is, for example, 0.75, the first memory space 260 becomes EH and the second memory space 270 becomes H. More specifically, the first memory space 260 is capable of storing the first-range pixels PIX1 of 3H scan lines, and the second memory space 270 is capable of storing second-range pixels PIX2 of H scan lines. With the above allocation, the image motion compensation circuit 230 can access the first-range pixels PIX1 of H scan lines and the second-range pixels PIX2 of 3H scan lines, and perform interpolation according to the image interpolation phase P.

In one embodiment, when the total size of the front image search range and the rear image search range generated by the allocation calculating circuit 520 is not greater than the space size (e.g., pixels of 4H scan lines) of the memory circuit 240, the image motion compensation circuit 230 may determine that, through the foregoing approach, the first-range pixels PIX1 are equivalent to the front image search range, and the second-pixels PIX2 are equivalent to the rear image search range, and perform interpolation based on the first-range pixels PIX1 and the second-range pixels PIX2.

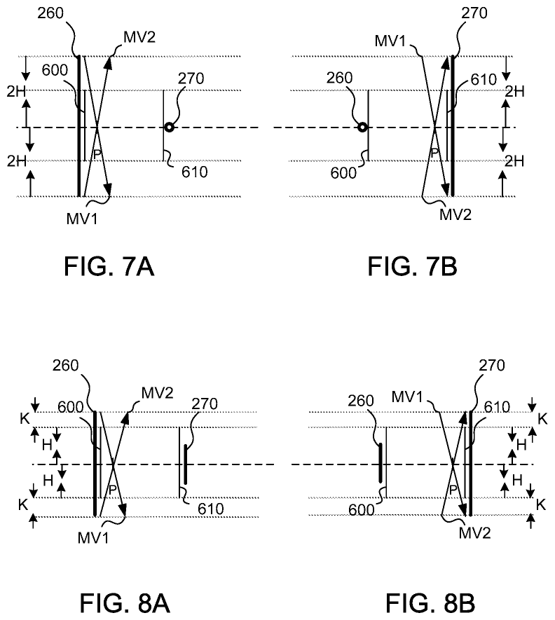

Referring to FIG. 7A and FIG. 7B, FIG. 7A and FIG. 7B are respectively allocation schematic diagrams of the first memory space 260 and the second memory space 270 according to an embodiment of the present invention. The space of the memory circuit 240 can at most store pixels of 4H scan lines.

In FIG. 7A, the motion vector MV1 and the motion vector MV2 are respectively motion vectors having the first maximum object displacement amount and the second maximum object displacement amount. The starting points of the motion vector MV1 and the motion vector MV2 are respectively at 2H scan lines above and below the center axis A of the image blocks, and the ending points thereof are respectively 2H scan lines below and above the center axis A of the image blocks. Thus, the first maximum object displacement amount and the second maximum object displacement amount have already exceeded 2H. According to the first maximum object displacement amount, the second maximum object displacement amount and the image interpolation phase P, the first calculating circuit 500 and the second calculating circuit 510 in FIG. 5 can learn through calculation that the first front image search range PRV1 and the second front image search range PRV2 are both 2H, and the first rear image search range NXT1 and the second rear image search range NXT2 both exceed 2H. The allocation calculating circuit 520 generates a front image search range having a size of 4H based on the first front image search range PRV1 and the second front image search range PRV2, and generates a rear image search range having a size greater than 4H based on the first rear image search range NXT1 and the second rear image search range NXT2. Further, because the image interpolation phase P is smaller than 0.5, the allocation calculating circuit 520 dynamically allocates all of the second predetermined memory space 610 to the first predetermined memory space 600, so as to form the final allocated first memory space 260 and second memory space 270. Thus, the first memory space 260 becomes 4H, and the second memory space 270 becomes 0. With the above allocation, the image motion compensation circuit 230 can access the first-range pixels PIX1 of 4H scan lines and the second-range pixels PIX2 of 0 scan line (equivalent to that data of the front image is read at all), and perform interpolation according to the image interpolation phase P.

In contrast, in FIG. 7B, the starting point of the motion vector MV1 and the motion vector MV2 respectively exceed 2H scan lines above and below the center axis A of the image blocks, the ending points thereof are respectively at 2H scan lines below and above the center axis A of the image blocks, and the image interpolation phase P is greater than 0.5. Thus, the allocation calculating circuit 520 dynamically allocates all of the first predetermined memory space 600 to the second predetermined memory space 610, so as to form the final allocated first memory space 260 and second memory space 270. With the above allocation, the image motion compensation circuit 230 can access the first-range pixels PIX1 of 0 scan line (equivalent to that data of the rear image is not at all read) and the second-range pixels PIX2 of the 4H scan lines, and perform interpolation according to the image interpolation phase P.

In the foregoing embodiments, when the size of at least one of the size of the front image search range and the rear image search range exceeds the space size (e.g., pixels of 4H scan lines) of the memory circuit 240, the image motion compensation circuit 230 can generate the interpolation image I by means of extrapolation based on the pixel values of one of the first-range pixels PIX1 and the second-range pixels PIX2.

FIG. 8A and FIG. 8B respectively show allocation schematic diagrams of the first memory space 260 and the second memory space 270 according to an embodiment of the present invention. The memory circuit 240 has a space that can at most store pixels of 4H scan lines.

In FIG. 8A, the starting points of the motion vector MV1 and the motion vector MV2 are respectively at H+K scan lines above and below the center axis A of the image blocks, the ending points thereof are respectively H+K scan lines below and above the center axis A of the image blocks, and the image interpolation phase P is smaller than 0.5 In this embodiment, the allocation calculating circuit 520 dynamically allocates a space having a size of K in the second predetermined memory space 610 to the first predetermined memory space 620, so as to form the final allocated first memory space 260 and second memory space 270. The first memory space 260 becomes 2(H+K), and the second memory space 270 becomes 2(H−K). With the above allocation, the image motion compensation circuit 230 can access the first-range pixels PIX1 of 2(H+K) scan lines and the second-range pixels PIX2 of 2(H−K) scan lines, and perform interpolation according to the image interpolation phase P.

In contrast, in FIG. 8B, the starting points of the motion vector MV1 and the second motion vector MV2 respectively exceeds H+K scan lines above and below the center axis A of the image blocks, the ending points thereof are respectively at H+K scan lines below and above the image blocks, and the image interpolation phase P is greater than 0.5. The allocation calculating circuit 520 dynamically allocates a space having a size of K in the first predetermined memory space 600 to the second predetermined memory space 610, so as to form the final allocated first memory space 260 and second memory space 270. The first memory space 260 becomes 2(H−K), and the second memory space 270 becomes 2(H+K). With the above allocation, the image motion compensation circuit 230 can access the first-range pixels PIX1 of 2(H−K) scan lines and the second-range pixels PIX2 of 2(H+K) scan lines, and perform interpolation according to the image interpolation phase P.

In one numerical example, in the first predetermined memory space 600 and the second predetermined memory space 610 respectively storing pixels of 2H scan lines, H is, for example but not limited to, 40; the image interpolation phase P is, for example but not limited to, ¼, 2/4 or ¾. When the image interpolation phase P is smaller or equal to 0.5, the first memory space 260 may be allocated as 70 and the second memory space 270 as 10. When the image interpolation phase P is greater than 0.5, the first memory space 260 may be allocated as 10, and the second memory space 270 as 70.

Referring to Table-1, Table-1 shows the maximum pixel ranges supported by a situation 1 where memory spaces cannot be dynamically allocated and a situation 2 where memory spaces can be dynamically allocated, and when interpolation is performed according to different image interpolation phases P.

TABLE 1

| | Phase | | |
|---|---|---|---|
| Situation | ¼ | 2/4 | ¾ |
| Situation 1 | +−160 | +−80 | +−160 |
| Situation 2 | +−280 | +−140 | +−280 |

When the memory spaces cannot be dynamically allocated and the image interpolation phase P is ¼, because H is 40, only pixels ranges of respectively 40/(¼)=160 above and below can be supported. When memory spaces can be dynamically allocated as H+K=70 and the image interpolation phase P is ¼, pixel ranges of respectively 70/(¼)=280 above and below can be supported. At this point, K is 30, i.e., a space of 30 scan lines in the second predetermined memory space 610 are allocated to the first predetermined memory space 600, thus obtaining the first memory space 260 of 70 and the second memory space 270 of 10.

When memory spaces cannot be dynamically allocated and the image interpolation phase P is ¾, because H is 40, only pixels ranges of respectively 40/(1/−(¾))=160 above and below can be supported. When memory spaces can be dynamically allocated as H+K=70 and the image interpolation phase P is ¾, pixel ranges of respectively 70/(1−(¾))=280 above and below can be supported. At this point, K is also 30, i.e., a space of 30 scan lines in the first predetermined memory space 600 is allocated to the second predetermined memory 610, thus obtaining the first memory space 260 of 70 and the second memory space 270 of 10.

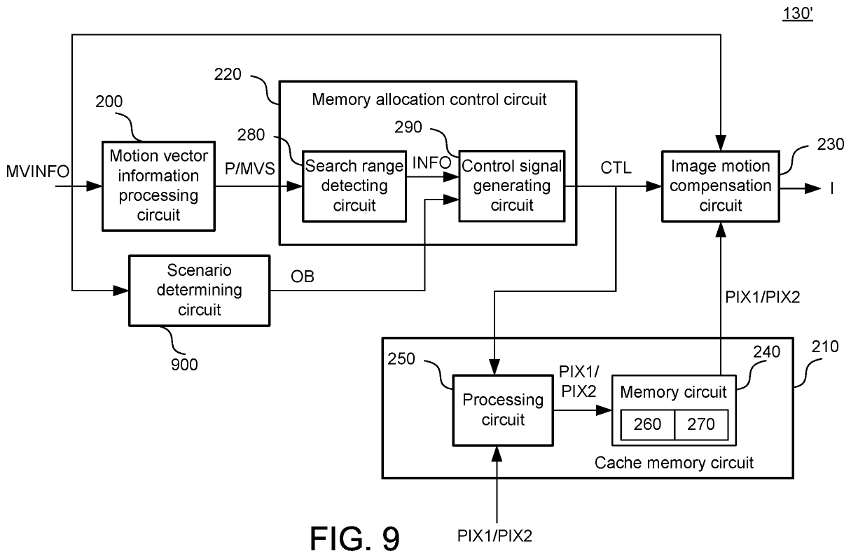

Referring to FIG. 9, FIG. 9 shows a block diagram of an image motion compensation device 130′ according to another embodiment of the present invention. The image motion compensation device 130′ can also be applied in the image processing device 100 in FIG. 1. Similar to the image motion compensation device 130 in FIG. 3, the image motion compensation device 130′ differs by further including a scenario determining circuit 900.

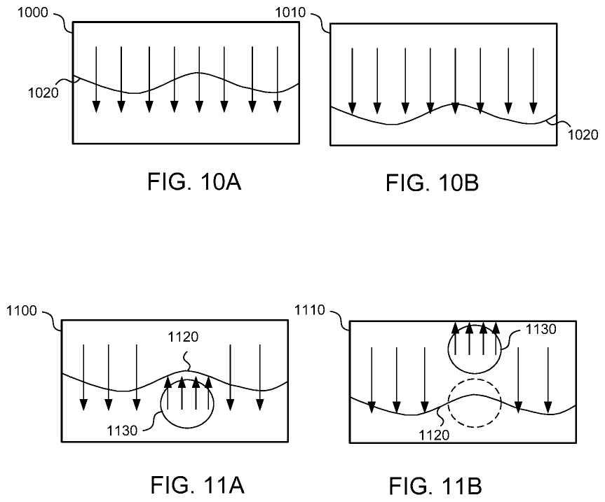

The scenario determining circuit 900 receives the motion vector information MVINFO to determine whether object blocking has occurred between a front image and a rear image to generate an object blocking determining signal OB. Referring to FIG. 10A and FIG. 10B, FIG. 10A and FIG. 10B respectively show schematic diagrams of a front image 1000 and a rear image 1010.

An object 1020 is included in the front image 1000 and the rear image 1010. The object 1020 moves along a direction between the front image 1000 and the rear image 1010 without having been blocked by another other object. Thus, the scenario determining circuit 900 determines that no blocking has occurred between the front image 1000 and the rear image 1010 according to the motion vector information MVINFO associated with the object 1020, and generates the object blocking determining signal OB in a value of 0.

Referring to FIG. 11A and FIG. 11B, FIG. 11A and FIG. 11B respectively show schematic diagrams of a front image 1100 and a rear image 1110 according to an embodiment of the present invention.

An object 1120 and an object 1130 are included in the front image 1100 and the rear image 1110. The object 1120 moves along a direction between the front image 1110 and the rear image 1110, and the object 1130 moves along an opposite direction between the front image 1100 and the rear image 1110, such that the object 1120 crosses the object 1130 and is blocked by the object 1130. Accordingly, the scenario determining circuit 900 determines that blocking has occurred between the front image 1100 and the rear image 1110 according to the motion vector information MVINFO associated with the object 1120, and generates the object blocking determining signal OB in a value of 1.

In one embodiment, the scenario determining circuit 900 may perform statistical calculation on the motion vector information, so as to only determine that blocking has occurred between the front image and the rear image when a blocked range of an object tis greater than a predetermined threshold, for example but not limited to, greater than a predetermined pixel number.

Thus, the control signal generating circuit 290 in FIG. 9 simultaneously generates the allocation control signal CTL further according to the allocation information INFO and the object blocking determining signal OB.

In one embodiment, when the object blocking determining signal OB indicates that the object blocking has occurred, the image motion compensation circuit 230 uses one of the first-range pixels PIX1 and the second-range pixels PIX2 to perform extrapolation. On the other hand, when object blocking determining signal OB indicates that no object blocking has occurred, the image motion compensation circuit 230 uses the first-range pixels PIX1 and the second-range pixels PIX2 to perform interpolation.

In conclusion, in addition to dynamically allocating the space of a cache memory circuit, the image motion compensation device of this embodiment is capable of further determining the mode of interpolation according whether object blocking has occurred, thus more flexibly utilizing the space of the cache memory circuit.

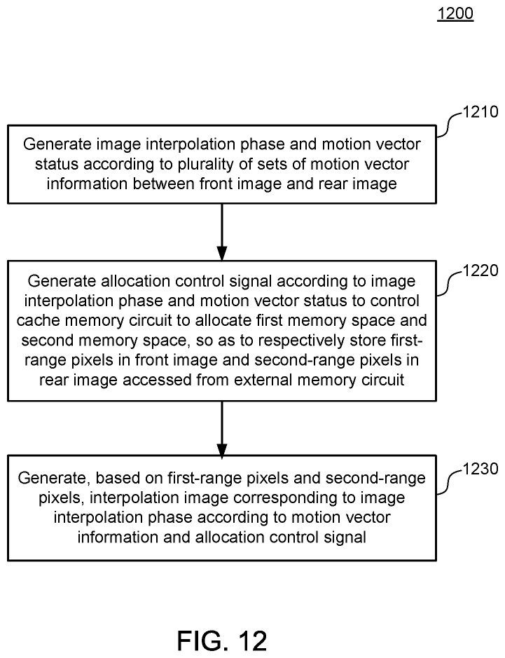

Referring to FIG. 12, FIG. 12 shows a flowchart of an image motion compensation method 1200 according to an embodiment of the present invention.

In addition to the foregoing circuit, the present invention further discloses an image motion compensation method 1200, which can be applied to, for example but not limited to, the image motion compensation device 130 in FIG. 2, to dynamically allocate spaces of a memory circuit. The image motion compensation method 1200 according to an embodiment includes the steps in FIG. 12.

In step S1210, an image interpolation phase and a motion vector status are generated according to a plurality of sets of motion vector information.

In step S1220, an allocation control signal is generated according to the image interpolation phase and the motion vector status to control a cache memory circuit to allocate a first memory space and a memory space, so as to respectively store first-range pixels of a front image and second-range pixels of a rear image accessed from an external memory circuit.

In step S1230, an interpolation image corresponding to the image interpolation phase is generated based on the first-range pixels and the second-range pixels according to the motion vector information and the allocation control signal.

In conclusion, the image processing device as well as the image motion compensation device and method thereof of the present invention are capable of dynamically allocating a first memory space and a second memory space according to an image interpolation phase and a motion vector status between a front image and a rear image, so as to respectively store first-range pixels of the front image and second-range pixels of the rear image to further perform image interpolation. Thus, the space of a cache memory circuit can be more efficiently utilized to achieve an image interpolation function to a larger extent.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image motion compensation device, comprising:
a motion vector information processing circuit, generating an image interpolation phase and a motion vector status according to a plurality of sets of motion vector information of a front image and a rear image;
a cache memory circuit, allocating a first memory space and a second memory space to respectively store first-range pixels of the front image and second-range pixels of the rear image read from an external memory circuit;
a memory allocation control circuit, generating a configuration control signal according to the image interpolation phase and the motion vector status to control the cache memory circuit to dynamically allocate sizes of the first memory space and the second memory space; and
an image motion compensation circuit, generating, based on the first-range pixels and the second-range pixels, an interpolation image corresponding to the image interpolation phase according to the motion vector information and the allocation control signal.

2. The image motion compensation device according to claim 1, wherein the motion vector information processing circuit generates the motion vector status according to a plurality of object displacement amounts in the motion vector information; the memory allocation control circuit comprises:
a search range detecting circuit, calculating a front image search range and a rear image search range according to the image interpolation phase and the motion vector status to determine a first scan line count of the first-range pixels and a second scan line count of the second-range pixels and to accordingly generate allocation information; and
a control signal generating circuit, generating the allocation control signal according to the allocation information.

3. The image motion compensation device according to claim 2, wherein the motion vector status comprises a first maximum object displacement amount corresponding to a first direction and a second maximum object displacement amount corresponding to a second direction; the search range detecting circuit comprises:
a first calculating circuit, performing calculation according to the first maximum object displacement amount and the image interpolation phase to generate a first front image search range and a first rear image search range;
a second calculating circuit, performing calculation according to the second maximum object displacement and the image interpolation phase to generate a second front image search range and a second rear image search range; and
an allocation calculating circuit, generating the front image search range based on the first front image search range and the second front image search range, generating the rear image search range based on the first rear image search range and the second rear image search range, and generating the allocation information according to the front image search range and the rear image search range.

4. The image motion compensation device according to claim 2, wherein the first-range pixels comprise at least a part of the front image search range, the second-range pixels comprise at least a part of the rear image search range, and the allocation control signal causes the image motion compensation circuit to perform interpolation according to the first-range pixels, the second-range pixels and the image interpolation phase to generate the interpolation image.

5. The image motion compensation device according to claim 2, wherein when the second scan line count of the second-range pixels is zero, the allocation control signal causes the image motion compensation circuit to perform extrapolation based on the first-range pixels and the image interphase phase to generate the interpolation image; when the first scan line count of the first-range pixels is zero, the allocation control signal causes the motion compensation circuit to perform extrapolation based on the second-range pixels and the image interpolation phase to generate the interpolation image.

6. The image motion compensation device according to claim 2, further comprising:
a scenario determining circuit, determining, according to the motion vector information, whether object blocking has occurred between the front image and the rear image to generate an object blocking determining signal;
wherein, the control signal generating circuit further generates the allocation control signal according to the allocation information and the object blocking determining signal, so as to cause the image motion compensation circuit to perform extrapolation based on one of the first-range pixels and the second-range pixels when the object blocking determining signal indicates that the object blocking has occurred to generate an interpolation image corresponding to the image interpolation phase.

7. The image motion compensation device according to claim 6, wherein the scenario determining circuit performs statistical calculation on the motion vector information, so as to determine that the object blocking has occurred between the front image and the rear image when a blocked range between the front image and the rear image is greater than a threshold.

8. The image motion compensation device according to claim 1, wherein the cache memory circuit comprises:
a memory circuit, comprising the first memory space and the second memory space; and
a processing circuit, receiving the allocation control signal from the memory allocation control circuit, and dynamically allocating the sizes of the first memory space and the second memory space according to the allocation control signal.

9. The image motion compensation device according to claim 1, wherein the cache memory circuit comprises a static random access memory (SRAM), and the external memory circuit comprises a dynamic random-access memory (DRAM).

10. The image motion compensation device according to claim 1, wherein a total of the first memory space and the second memory space is not greater than a predetermined value.

11. An image motion compensation method, applied in an image motion compensation device, comprising:
generating an image interpolation phase and a motion vector status according to a plurality of sets of motion vector information of a front image and a rear image;
generating an allocation control signal according to the image interpolation phase and the motion vector status to generate an allocation control signal to control a cache memory circuit to allocate a first memory space and a second memory space, so as to respectively store first-range pixels of the front image and second-range pixels of the rear image accessed from an external memory circuit; and
generating, based on the first-range pixels and the second-range pixels, an interpolation image corresponding to the image interpolation phase according to the motion vector information and the allocation control signal.

12. The image motion compensation method according to claim 11, wherein the step of generating the image interpolation phase comprises:
generating the motion vector status according to a plurality of object displacement amounts in the motion vector information; and
the step of generating the allocation control signal comprises:
calculating a front image search range and a rear image search range according to the image interpolation phase and the motion vector status, so as to determine a first scan line count of the first-range pixels and a second scan line count of the second-range pixels to accordingly generate allocation information; and
generating the allocation control signal according to the allocation information.

13. The image motion compensation method according to claim 12, wherein the motion vector status comprises a first maximum displacement amount corresponding to a first direction and a second maximum object displacement amount corresponding to a second direction; the step of generating the allocation information comprises:
performing calculation according to the first maximum object displacement amount and the image interpolation phase to generate a first front image search range and a first rear image search range;
performing calculation according to the second maximum object displacement amount and the image interpolation phase to generate a second front image search range and a second rear image search range; and
generating the front image search range based on the first front image search range and the second front image search range, generating the rear image search range based on the first rear image search range and the second rear image search range, and generating the allocation information according to the front image search range and the rear image search range.

14. The image motion compensation method according to claim 12, wherein the first-range pixels at least comprise a part of the front image search range, the second-range pixels at least comprise a part of the rear image search range, and the step of generating the interpolation image corresponding to the image interpolation phase comprises:
performing interpolation according to the first-range pixels, the second-range pixels and the image interpolation phase to generate the interpolation image.

15. The image motion compensation method according to claim 12, wherein the step of generating the interpolation image corresponding to the image interpolation phase comprises:
performing extrapolation based on the first-range pixels and the image interpolation phase when the second scan line count of the second-range pixels is zero to generate the interpolation image; and
performing extrapolation based on the second-range pixels and the image interpolation phase when the first scan line count of the first-range pixels is zero to generate the interpolation image.

16. The image motion compensation method according to claim 12, further comprising:
determining, according to the motion vector information, whether object blocking has occurred between the front image and the rear image to generate an object blocking determining signal; and
generating the allocation control signal according to the allocation information and the object blocking determining signal, so as to perform extrapolation based on one of the first-range pixels and the second-range pixels when the object blocking determining signal indicates that the object blocking has occurred to generate an interpolation image corresponding to the image interpolation phase.

17. The image motion compensation method according to claim 16, wherein the step of determining whether the object blocking has occurred between the front image and the rear image comprises:
performing statistical calculation on the motion vector information, and determining that the object blocking has occurred between the front image and the rear image when a blocked range between the front image and the rear image is greater than a threshold.

18. The image motion compensation method according to claim 11, wherein a total of the first memory space and the second memory space is not greater than a predetermined value.
